(19) United States
(12) Patent Application Publication
(10) Pub. No.: US 2026/0176177 A1
(43) Pub. Date: Jun. 25, 2026

(54) MINERALIZATION WATERWAY SYSTEM AND MINERALIZATION WATER PURIFIER

(71) Applicant: Guangdong Lizi Technology Co., Ltd., Foshan (CN)

(72) Inventors: Erqiang Duan, Foshan (CN); Guoxiang Chen, Foshan (CN); Xing Zhan, Foshan (CN); Yutai Huang, Foshan (CN); Wenbin Chen, Foshan (CN); Jiawei Chen, Foshan (CN); Yijie Hao, Foshan (CN); Mingyao Li, Foshan (CN)

(21) Appl. No.: 19/026,152

(22) Filed: Jan. 16, 2025

(30) Foreign Application Priority Data
Dec. 19, 2024 (CN) 202411889768.9

(51) Int. Cl. C02F 1/68; C02F 1/00; C02F 1/28; C02F 1/66; C02F 101/16; C02F 101/20

(52) U.S. Cl. CPC C02F 1/685; C02F 1/008; C02F 1/281; C02F 1/66; C02F 2101/16; C02F 2101/20; C02F 2201/005; C02F 2209/10; C02F 2209/40

(57) ABSTRACT

A mineralization waterway system and a mineralization water purifier include a mineralization waterway, an inhibition waterway, and an acceleration waterway. The mineralization waterway includes a mineralization pipeline and a mineralization filter element; the inhibition waterway includes an inhibition pipeline and an inhibition filter element; and the acceleration waterway includes an acceleration pipeline and an acceleration filter element. The waterway system further includes a first connection waterway connected between the mineralization waterway and the inhibition waterway, used to allow water flowing through the inhibition filter element to enter the mineralization waterway; and a second connection waterway connected between the mineralization waterway and the acceleration waterway, used to allow water flowing through the acceleration filter element to enter the mineralization waterway. The mineralization waterway system can prevent the mineral content in the water from being too high, and also prevent the mineral content in the water from not meeting the standard.

### CROSS REFERENCE TO RELATED APPLICATIONS

The present application claims the benefit of Chinese Patent Application No. 202411889768.9 filed on Dec. 19, 2024, the contents of which are incorporated herein by reference in their entirety.

### TECHNICAL FIELD

The present disclosure relates to the technical field of water purification, and in particular, to a mineralization waterway system and a mineralization water purifier including the mineralization waterway system.

### BACKGROUND

With the improvement of the living quality, people have increasingly high requirements for drinking water. It is hoped that water purified by a water purification system can contain minerals beneficial for a human body. Therefore, products that mineralize purified water through a mineralization filter element have emerged. Due to design flaws, these products can currently release excessive minerals or can have a situation that the release amount of minerals does not meet a standard, especially in a scenario with a high flow rate, the release amount of minerals cannot reach a preset standard range.

### SUMMARY

The present disclosure provides a mineralization waterway system and a mineralization water purifier, aiming to solve the technical problem that water provided by existing water purifier contains excessive minerals or minerals contained in the water provided by the water purifier do not meet a standard.

According to a first aspect of the present disclosure, an embodiment provides a mineralization waterway system, including a mineralization waterway, an inhibition waterway, and an acceleration waterway, wherein the mineralization waterway, the inhibition waterway, and the acceleration waterway are arranged in parallel and can simultaneously or separately discharge water;
the mineralization waterway includes a mineralization pipeline and a mineralization filter element arranged at the mineralization pipeline; the inhibition waterway includes an inhibition pipeline and an inhibition filter element arranged at the inhibition pipeline; and the acceleration waterway includes an acceleration pipeline and an acceleration filter element arranged at the acceleration pipeline;
the mineralization waterway system further includes a first connection waterway and a second connection waterway; the first connection waterway is connected between the mineralization waterway and the inhibition waterway to allow water flowing through the inhibition filter element to enter the mineralization waterway; and the second connection waterway is connected between the mineralization waterway and the acceleration waterway to allow water flowing through the acceleration filter element to enter the mineralization waterway.

In an embodiment, the first connection waterway includes a first connection pipeline and a first valve body arranged at the first connection pipeline; and the first valve body is a switch valve or a check valve.

In an embodiment, the second connection waterway includes a second connection pipeline and a second valve body arranged at the second connection pipeline.

In an embodiment, the second valve body is a switch valve or a check valve.

In an embodiment, the mineralization waterway further includes a first control valve for controlling the mineralization waterway to be opened and closed; and the first control valve is arranged at an upstream end of the mineralization filter element.

In an embodiment, one end of the first connection waterway is connected between the first control valve and the mineralization filter element; and one end of the second connection waterway is connected between the first control valve and the mineralization filter element.

In an embodiment, the inhibition waterway further includes a second control valve for controlling the inhibition pipeline to be opened and closed; the second control valve is arranged at a downstream end of the inhibition filter element; and the other end of the first connection waterway is connected between the inhibition filter element and the second control valve.

In an embodiment, the acceleration waterway further includes a third control valve for controlling the acceleration pipeline to be opened and closed; the third control valve is arranged at a downstream end of the acceleration filter element; and the other end of the second connection waterway is connected between the acceleration filter element and the third control valve.

In an embodiment, the mineralization waterway system further includes a water inlet waterway and a water outlet waterway, wherein the mineralization waterway, the inhibition waterway, and the acceleration waterway are connected in parallel between the water inlet waterway and the water outlet waterway.

In an embodiment, the mineralization waterway system further includes a flow detector for detecting a flow rate of water.

In an embodiment, the mineralization waterway system further includes a Total Dissolved Solids (TDS) detector for detecting a TDS value of water.

In an embodiment, the mineralization filter element includes a metasilicic-acid-containing filter material; the acceleration filter element includes an alkaline filter material; and the inhibition filter element includes a zeolite filter material.

In an embodiment, the mineralization filter element includes maifanite; the acceleration filter element includes periclase; and the inhibition filter element includes zeolite.

According to a second aspect of the present disclosure, an embodiment provides a mineralization water purifier, including the mineralization waterway system in the first aspect.

In an embodiment, the first connection waterway includes a first connection pipeline and a first valve body arranged at the first connection pipeline.

In an embodiment, the second connection waterway includes a second connection pipeline and a second valve body arranged at the second connection pipeline.

In an embodiment, the mineralization waterway further includes a first control valve for controlling the mineralization pipeline to be opened and closed; the first control valve is arranged at an upstream end of the mineralization filter element;
one end of the first connection waterway is connected between the first control valve and the mineralization filter element; and one end of the second connection waterway is connected between the first control valve and the mineralization filter element.

In an embodiment, the inhibition waterway further includes a second control valve for controlling the inhibition pipeline to be opened and closed; the second control valve is arranged at a downstream end of the inhibition filter element; and the other end of the first connection waterway is connected between the inhibition filter element and the second control valve.

In an embodiment, the acceleration waterway further includes a third control valve for controlling the acceleration pipeline to be opened and closed; the third control valve is arranged at a downstream end of the acceleration filter element; and the other end of the second connection waterway is connected between the acceleration filter element and the third control valve.

In an embodiment, the mineralization water purifier further includes a water inlet waterway and a water outlet waterway, wherein the mineralization waterway, the inhibition waterway, and the acceleration waterway are connected in parallel between the water inlet waterway and the water outlet waterway.

According to the mineralization water system and the mineralization water purifier of the above embodiments, by arranging the first connection waterway, water containing an inhibitory substance can flow into the mineralization filter element through the first connection waterway, so that the inhibitory substance can inhibit the mineralization filter element from releasing minerals, to reduce the mineral content of the water, thereby preventing an excessive mineral content of the water. By arranging the second connection waterway, water containing an accelerant flows into the mineralization filter element through the second connection waterway, so that the accelerant can accelerate the release of minerals from the mineralization filter element, thereby increasing the mineral content of the water and then avoiding that the mineral content of the water does not meet a standard.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art can still derive other drawings from the structures shown in the accompanying drawings without creative efforts.

FIG. 1 is a schematic structural diagram of a mineralization waterway system according to an embodiment of the present disclosure;

FIG. 2 is a diagram of a flowing direction of water of a mineralization waterway system when a mineralization waterway, an inhibition waterway, and an acceleration waterway simultaneously discharge water according to an embodiment of the present disclosure;

FIG. 3 is a diagram of a flowing direction of water of a mineralization waterway system when a mineralization filter element is in a soaked state according to an embodiment of the present disclosure;

FIG. 4 is a diagram of a flowing direction of water of a mineralization waterway system during prevention of an excessive mineral content caused by soaking of a mineralization filter element and adding of a new kind of mineral into water according to an embodiment of the present disclosure;

FIG. 5 is a diagram of a flowing direction of water of a mineralization waterway system when a mineralization filter element is in a middle to late stage of its service life according to an embodiment of the present disclosure; and

FIG. 6 is a diagram of a flowing direction of water of a mineralization waterway system when it is expected that there is a large flow rate and a new kind of mineral is added into water according to an embodiment of the present disclosure.

### REFERENCE NUMERALS IN THE ACCOMPANYING DRAWINGS

100: mineralization waterway system; 10: mineralization waterway; 11: mineralization pipeline; 12: mineralization filter element; 13: first control valve; 20: inhibition waterway; 21: inhibition pipeline; 22: inhibition filter element; 23: second control valve; 30: acceleration waterway; 31: acceleration pipeline; 32: acceleration filter element; 33: third control valve; 40: water inlet waterway; 50: water outlet waterway; 60: first connection waterway; 61: first connection pipeline; 62: first valve body; 70: second connection waterway; 71: second connection pipeline; and 72: second valve body.

The objective implementation, functional features and advantages of the present disclosure are further illustrated with reference to the accompanying drawings by using the embodiments.

### DETAILED DESCRIPTION OF THE EMBODIMENTS

The technical solutions in the embodiments of the present disclosure will be clearly and completely described below with reference to the drawings in the embodiments of the present disclosure, and it is obvious that the described embodiments are only a part of the embodiments of the present disclosure but not all of them. All other embodiments obtained by a person of ordinary skill in the art based on the embodiments of the present disclosure without creative efforts shall fall within the protection scope of the present disclosure.

It should be noted that all directional indications (such as up, down, left, right, front, back, . . . ) involved in the embodiments of the present disclosure are only used to explain the relative positional relationship, motion states, and the like between various components in specific postures. If the specific postures change, the directional indications also change correspondingly.

It should be also noted that when an element is referred to as being “fixed to” or “arranged to” another element, the element can be directly on another element or there can be a centered element. When an element is referred to as being “connected” to another element, the element can be directly connected to another element or there can be a centered element.

In addition, the descriptions of the terms “first”, “second”, and the like in the present disclosure are used for descriptive purposes only and are not to be construed as indicating or implying relative importance or to implicitly indicate the number of technical features indicated. From this, features defined as “first” and “second” can explicitly or implicitly include at least one feature. In addition, the technical solutions between the various embodiments can be combined with each other, but need to be implemented by those of ordinary skill in the art. When there is a conflict in a combination of technical solutions or the combination cannot be achieved, it should be considered that the combination of the technical solutions does not exist and does not fall within the protection scope of the present disclosure.

A reverse osmosis membrane filtering technology used by water purification equipment can filter out all substances in water. Purified water without any beneficial elements is not healthy water in a sense and does not conform to the concept of healthy water. Therefore, products that mineralize purified water through a mineralization filter element have emerged. However, in the related technology, there can be situations that the release (dissolution) amount of minerals is small, making a mineral content in water not meet a standard, and the release amount of minerals is large, causing a large mineral content of water and affecting the health of a human body.

In view of this, the present disclosure provides a mineralization waterway system and a mineralization water purifier, which can enhance mineral release when the release (dissolution) amount of minerals does not meet the standard, and reduce mineral release when excessive minerals are released.

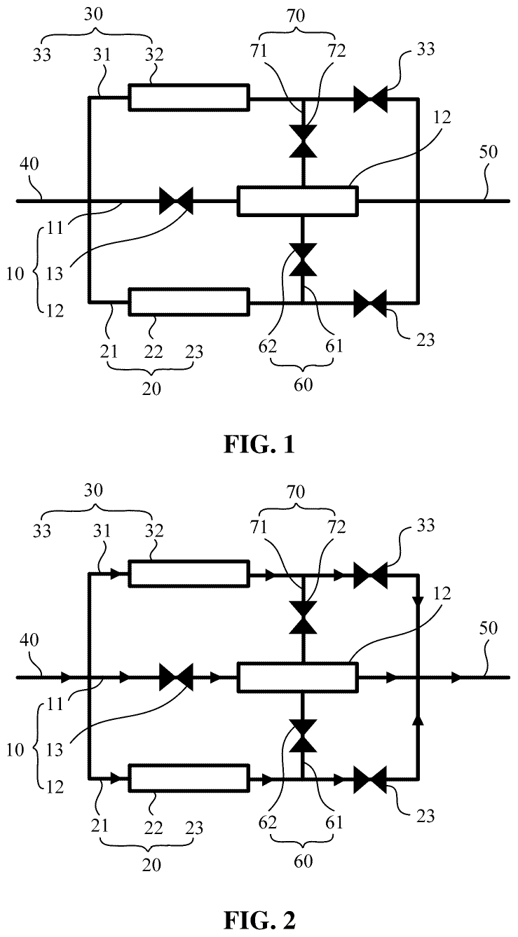

As shown in FIG. 1, a mineralization water system 100 provided in an embodiment of the present disclosure includes a mineralization waterway 10, an inhibition waterway 20, and an acceleration waterway 30. The mineralization waterway 10 includes a mineralization pipeline 11 and a mineralization filter element 12 arranged at the mineralization pipeline 11. The inhibition waterway 20 includes an inhibition pipeline 21 and an inhibition filter element 22 arranged at the inhibition pipeline 21. The acceleration waterway 30 includes an acceleration pipeline 31 and an acceleration filter element 32 arranged at the acceleration pipeline 31.

The mineralization filter element 12 can release (dissolve) minerals into water flowing therethrough, thereby making the water contain the minerals, to meet a requirement of people for mineralized drinking water. The inhibition filter element 22 can release an inhibitory substance into water flowing therethrough. When the water containing the inhibitory substance flows through the mineralization filter element 12, the inhibitory substance can inhibit the release of minerals from the mineralization filter element 12, thereby avoiding a situation that the mineral content of the water is high. The acceleration filter element 32 can release an accelerant into water flowing therethrough. When the water containing the accelerant flows through the mineralization filter element 12, the accelerant can accelerate the release of minerals from the mineralization filter element 12, thereby increasing the mineral content of the water.

By arranging the mineralization waterway 10 including the mineralization pipeline 11 and the mineralization filter element 12 arranged at the mineralization pipeline 11, it is possible to make the water output from the mineralization pipeline 11 contain the minerals, so that the mineralization waterway 10 outputs the water containing the minerals. By arranging the inhibition waterway 20 including the inhibition pipeline 21 and the inhibition filter element 22 arranged at the inhibition pipeline 21, it is possible to make the water output from the inhibition pipeline 21 contain the inhibitory substance, so that the release of minerals from the mineralization filter element 12 is inhibited. By arranging the acceleration waterway 30 including the acceleration pipeline 31 and the acceleration filter element 32 arranged at the acceleration pipeline 31, it is possible to make the water output from the acceleration pipeline 31 contain the accelerant, so that the release of minerals from the mineralization filter element 12 is accelerated.

The mineralization waterway 10, the inhibition waterway 20, and the acceleration waterway 30 are arranged in parallel and can simultaneously discharge water. In this way, water containing the minerals in the mineralization waterway 10, water containing the inhibitory substance in the inhibition waterway 20, and water containing the accelerant in the acceleration waterway 30 can be discharged after being mixed. The mineralization waterway 10, the inhibition waterway 20, and the acceleration waterway 30 can further separately discharge water. People can obtain the water containing the minerals from the mineralization waterway 10, obtain the water containing the inhibitory substance from the inhibition waterway 20, and obtain the water containing the accelerant from the acceleration waterway 30. Any two of the mineralization waterway 10, the inhibition waterway 20, and the acceleration waterway 30 can simultaneously discharge water. Therefore, the mineralization waterway system100 of this embodiment can provide different types of water.

It can be understood that in other embodiments, the mineralization waterway 10, the inhibition waterway 20, and the acceleration waterway 30 can also be connected to different water outlet ends respectively, so that the water in the mineralization waterway 10, the water in the inhibition waterway 20, and the water in the acceleration waterway 30 can be discharged separately.

Referring to FIG. 1, the mineralization waterway system 100 further includes a water inlet waterway 40 and a water outlet waterway 50. The mineralization waterway 10, the inhibition waterway 20, and the acceleration waterway 30 are connected in parallel between the water inlet waterway 40 and the water outlet waterway 50. In this way, the parallel arrangement of the mineralization waterway 10, the inhibition waterway 20, and the acceleration waterway 30 is achieved. The water inlet waterway 40 can be connected to the mineralization waterway 10, the inhibition waterway 20, and the acceleration waterway 30 through a multi-way valve or a flow divider valve. The mineralization waterway 10, the inhibition waterway 20, and the acceleration waterway 30 can be connected to the water outlet waterway 50 through a multi-way valve. When the mineralization waterway 10, the inhibition waterway 20, and the acceleration waterway 30 simultaneously discharge water, the water from the mineralization pipeline 11, the inhibition pipeline 21, and the acceleration pipeline 31 can be discharged through the water outlet pipeline 50 after being mixed.

Referring to FIG. 1, the mineralization waterway system 100 further includes a first connection waterway 60. The first connection waterway 60 is connected between the mineralization waterway 10 and the inhibition waterway 20 to allow water flowing through the inhibition filter element 22 to enter the mineralization waterway 10. In this way, the water containing the inhibitory substance can flow into the mineralization filter element 12 through the first connection waterway 60, so that the inhibitory substance can inhibit the mineralization filter element 12 from releasing minerals, to reduce the mineral content of the water, thereby preventing an excessive mineral content of the water. Particularly, when the mineralization filter element 12 is in a soaked state, for example, if the water in the mineralization waterway 10 flows too slowly, or if outputting of water stops, or after outputting of water stops for a set duration, it can cause the mineral content of the water (especially in the mineralization filter element 12) to be too high. By using the first connection waterway 60, the water containing the inhibitory substance can enter the mineralization filter element 12, so that the inhibitory substance can inhibit the mineralization filter element 12 in the soaked state from releasing minerals and prevent an excessive mineral content of the water. The soaked state described in this embodiment means a situation that a flow rate in the filter element is less than a design threshold, including a situation that water stops flowing, the flowing is slow, or the like.

Referring to FIG. 1, the mineralization waterway system 100 further includes a second connection waterway 70. The second connection waterway 70 is connected between the mineralization waterway 10 and the acceleration waterway 30 to allow water flowing through the acceleration filter element 32 to enter the mineralization waterway 10. In this way, the water containing the accelerant flows into the mineralization filter element 12 through the second connection waterway 70, so that the accelerant can accelerate the release of minerals from the mineralization filter element 12, thereby increasing the mineral content of the water and then avoiding that the mineral content of the water does not meet a standard. Particularly, when the flow rate of the water in the mineralization waterway 10 exceeds a preset flow rate (i.e. the water has a large flow rate), or when the mineralization filter element 12 has been used for a period of time and reaches the middle to late stage of its service life, the amount of minerals released by the mineralization filter element 12 decreases. The accelerant is used to accelerate the release of minerals from the mineralization filter element 12, so that the mineral content of the water can be effectively increased.

Therefore, according to the mineralization waterway system 100 of this embodiment, the water containing the inhibitory substance is conveyed to the mineralization filter element 12, to inhibit the release of minerals from the mineralization filter element 12, thereby preventing an excessive mineral content of the water. Furthermore, the water containing the accelerant is conveyed to the mineralization filter element 12 to accelerate the release of minerals from the mineralization filter element 12, to prevent the phenomenon that the mineral content of the water does not meet the standard.

Referring to FIG. 1, the first connection waterway 60 includes a first connection pipeline 61 and a first valve body 62 arranged at the first connection pipeline 61. The first valve body 62 has a state of allowing water to flow through and a state of not allowing water to flow through. In specific applications, the first valve body 62 can also be a flow valve.

Since the first valve body 62 is arranged at the first connection pipeline 61, it is possible to control whether the water can flow through the first connection pipeline 61 from the inhibition filter element 22 to the mineralization filter element 12. For example, when the mineralization filter element 12 is in the soaked state, the first valve body 62 can be made in the state of allowing water to flow through. Therefore, the water can flow from the inhibition filter element 22 to the mineralization filter element 12 through the first connection pipeline 61, so that the inhibitory substance can inhibit the mineralization filter element 12 from releasing minerals, to reduce the mineral content of the water, prevent the mineral content from exceeding a preset standard, and control the mineral content in a safe standard range. When the flow rate of the water flowing through the mineralization pipeline 11 exceeds a preset flow rate, a concentration of the minerals in the water flowing through the mineralization filter element 12 cannot exceed the preset standard, and the first valve body 62 can be made in the state of not allowing water to flow through.

Referring to FIG. 1, the second connection waterway 70 includes a second connection pipeline 71 and a second valve body 72 arranged at the second connection pipeline 71. The second valve body 72 has a state of allowing water to flow through and a state of not allowing water to flow through. In specific applications, the second valve body 72 can also be a flow valve.

Since the second valve body 72 is arranged at the second connection pipeline 71, it is possible to control whether the water can flow through the second connection pipeline 71 from the acceleration filter element 32 to the mineralization filter element 12. For example, when the water in the mineralization waterway 10 has a large flow rate, or when the mineralization filter element 12 has reached the middle to late stage of its service life, the second valve body 72 can be in the state of allowing water to flow through. Therefore, the water can flow from the acceleration filter element 32 to the mineralization filter element 12 through the second connection pipeline 71, so that the accelerant can accelerate the release of minerals from the mineralization filter element 12, to increase the mineral content of the water, prevent the mineral content from being less than the preset standard, and control the mineral content in the safe standard range. When the flow rate of the water in the mineralization waterway 10 is less than the preset flow rate, or when the mineralization filter element 12 has reached the middle to late stage of its service life, a concentration of the minerals in the water that flows through the mineralization filter element 12 cannot be less than the preset standard. When the mineral content of the water meets the standard, the first valve body 62 can be in the state of not allowing water to flow through.

Referring to FIG. 1, the mineralization waterway 10 further includes a first control valve 13 for controlling the mineralization pipeline 11 to be opened and closed. The first control valve 13 is arranged at an upstream end of the mineralization filter element 12. By controlling opening or closing of the first control valve 13, it is possible to determine whether to convey water to the mineralization filter element 12. The flow rate of the mineralization pipeline 11 is controlled through the first control valve 13, so that an amount of minerals released by the mineralization filter element 12 into water per unit volume can be controlled. Specifically, when the flow rate of water in the mineralization pipeline 11 is greater than the preset flow rate, the mineral content of water per unit volume can decrease. When the flow rate of water in the mineralization pipeline 11 is less than the preset flow rate, the mineral content of water per unit volume can increase. Therefore, the flow rate of the mineralization pipeline 11 can be adjusted through the first control valve 13, thereby adjusting the mineral content of the water in the mineralization pipeline 11.

Referring to FIG. 1, the inhibition waterway 20 further includes a second control valve 23 for controlling opening and closing and/or a flow rate of the inhibition pipeline 21. The second control valve 23 is arranged at a downstream end of the inhibition filter element 22. It can be achieved, by controlling opening or closing of the second control valve 23, whether to convey water to the inhibition filter element 22. The acceleration waterway 30 further includes a third control valve 33 for controlling opening and closing and/or a flow rate of the acceleration pipeline 31. The third control valve 33 is arranged at a downstream end of the acceleration filter element 32. It can be achieved, by controlling opening or closing of the fifth control valve 33, whether to convey water to the acceleration filter element 32.

One end of the first connection waterway 60 is connected between the first control valve 13 and the mineralization filter element 12, and the other end of the first connection waterway 60 is connected between the inhibition filter element 22 and the second control valve 23. Since the first control valve 13 is arranged at the upstream end of the mineralization filter element 12 and the second control valve 23 is arranged at the downstream end of the inhibition filter element 22, an input end of the first connection pipeline 61 is connected to the downstream end of the inhibition filter element 22, and an output end of the first connection pipeline 61 is connected to the upstream end of the mineralization filter element 12. When the first control valve 13 and the second control valve 23 are controlled to be closed, and the first valve body 62 is in the state of allowing water to flow through, the water containing the inhibitory substance can flow to the first connection pipeline 61 and then to the mineralization filter element 12.

One end of the second connection waterway 70 is connected between the first control valve 13 and the mineralization filter element 12, and the other end of the second connection waterway 70 is connected between the acceleration filter element 32 and the third control valve 33. Since the first control valve 13 is arranged at the upstream end of the mineralization filter element 12 and the third control valve 33 is arranged at the downstream end of the acceleration filter element 32, the input end of the second connection pipeline 71 is connected to the downstream end of the acceleration filter element 32, and the output end of the second connection pipeline 71 is connected to the upstream end of the mineralization filter element 12. When the first control valve 13 and the third control valve 33 are controlled to be closed, and the second valve body 72 is in the state of allowing water to flow through, the water containing the accelerant can flow to the second connection pipeline 71 and then to the mineralization filter element 12.

By the arrangement of the first control valve 13, the second control valve 23, the third control valve 33, the first valve body 62, and the second valve body 72, the mineralization waterway 10, the inhibition waterway 20, and the acceleration waterway 30 can simultaneously or separately output water, or the water flowing through the inhibition filter element 22 can enter the mineralization filter element 12 through the first connection waterway 60, or the water flowing through the acceleration filter element 32 can enter the mineralization filter element 12 through the second connection waterway 70, to make the waterway system meet different requirements.

For example, referring to FIG. 2, when the mineralization waterway 10, the inhibition waterway 20, and the acceleration waterway 30 need to discharge water simultaneously, the first control valve 13, the second control valve 23, and the third control valve 33 can be controlled to be opened, and the first valve body 62 and the second valve body 72 can be controlled to be in the state of not allowing water to pass through. In this case, the first connection waterway 60 and the second connection waterway 70 are both blocked, and the mineralization waterway 10, the inhibition waterway 20, and the acceleration waterway 30 are connected between the water inlet waterway 40 and the water outlet waterway 50 and are arranged in parallel. The water in the mineralization waterway 10, the water in the inhibition waterway 20, and the water in the acceleration waterway 30 are discharged after being mixed in the water outlet pipeline 50.

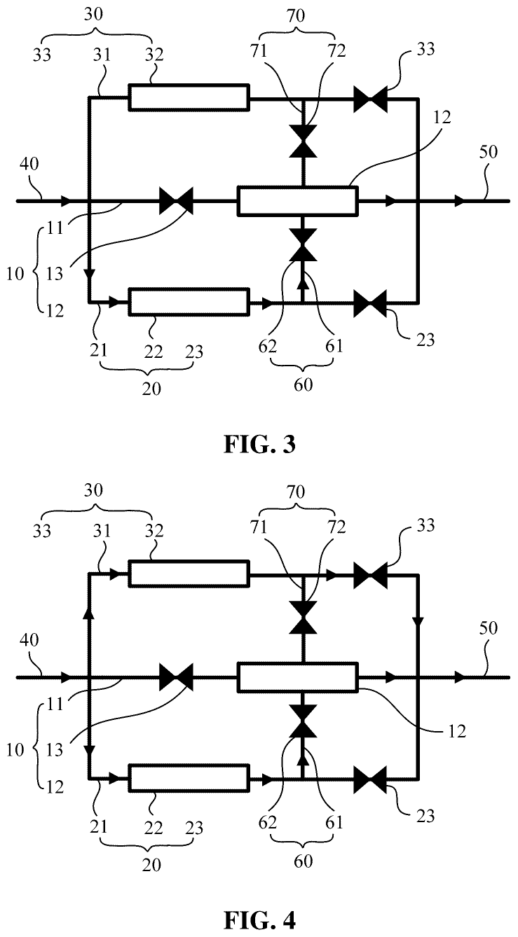

For example, referring to FIG. 3, when the mineralization filter element 12 is in the soaked state, the first valve body 62 can be controlled to be in the state of allowing water to pass through; the second valve body 72 can be controlled to be in the state of not allowing water to pass through; and the first control valve 13, the second control valve 23, and the third control valve 33 can be controlled to be closed. In this way, both the second connection waterway 70 and the acceleration waterway 30 are blocked. The inhibition filter element 22 and the mineralization filter element 12 are connected through the first connection waterway 60. The water containing the inhibitory substance can flow through the first connection waterway 60 to the mineralization filter element 12, thus allowing the water containing the inhibitory substance to enter and fill the mineralization filter element 12. The mineralization filter element 12 can be soaked in the water containing the inhibitory substance.

For example, referring to FIG. 4, to prevent an excessive mineral content caused by soaking of the mineralization filter element 12, when a new kind of mineral is added into the water, the first valve body 62 can be controlled to be in the state of allowing water to flow through; the second valve body 72 can be controlled to be in the state of not allowing water to flow through; the first control valve 13 and the second control valve 23 can be controlled to be closed; and the third control valve 33 can be controlled to be opened. In this case, the second connection waterway 70 is blocked. The inhibition filter element 22 and the mineralization filter element 12 are connected through the first connection waterway 60. The water containing the inhibitory substance can flow to the mineralization filter element 12 through the first connection waterway 60, thereby inhibiting the release of minerals from the mineralization filter element 12 and preventing the mineral content of the water from exceeding a standard content. The acceleration waterway 30 is unblocked, so that the water containing the accelerant can flow to the water outlet waterway 50. The acceleration filter element 32 can include a filter material that releases minerals, thereby adding the new kind of mineral into the water. For example, the acceleration filter element 32 includes a periclase filter material described below. The periclase filter material is an alkaline filter material, and released (dissolved) periclase can adjust the pH value of water, to improve the taste of drinking water and maintain a healthy state of a human body.

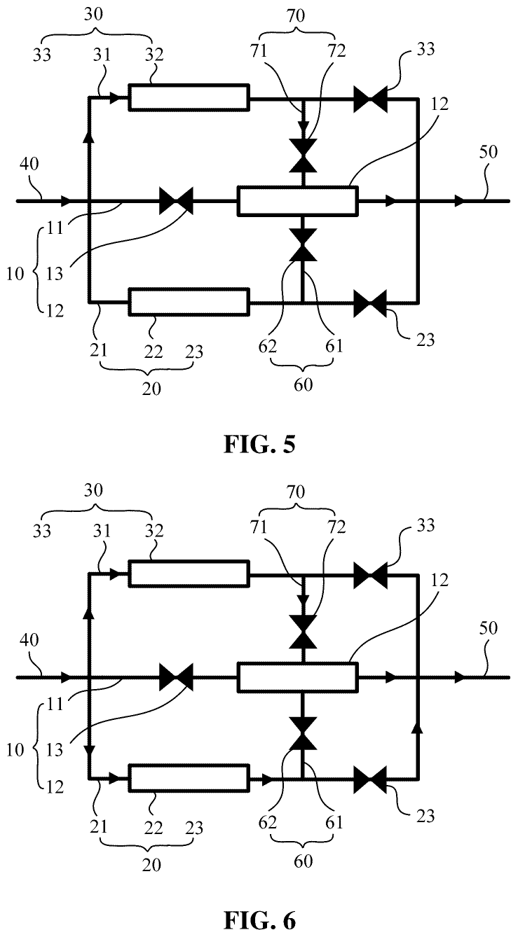

For example, referring to FIG. 5, when the mineralization filter element 12 is the middle to late stage of its service life, the first valve body 62 can be controlled to be in the state of not allowing water to flow through; the second valve body 72 can be controlled to be in the state of allowing water to flow through; and the first control valve 13, the second control valve 23, and the third control valve 33 can be controlled to be closed. In this case, both the first connection waterway 60 and the inhibition waterway 20 are blocked, and the acceleration filter element 32 and the mineralization filter element 12 are connected through the second connection waterway 70. The water containing the accelerant can flow to the mineralization filter element 12 through the second connection waterway 70, thereby accelerating the release of minerals from the mineralization filter element 12 and ensuring that the minerals in the water can meet a standard. Even if the mineralization filter element 12 is in the middle to late stage of its lifespan (the dissolution rate of minerals decreases), by using the acceleration filter element 32, the dissolution rate of the minerals in the mineralization filter element 12 is maintained within a set range, and the service life of the mineralization filter element 12 can be prolonged. Or, in an expected large flow rate, the first valve body 62 can be controlled to be in the state of not allowing water to flow through; the second valve body 72 can be controlled to be in the state of allowing water to flow through; and the first control valve 13, the second control valve 23, and the third control valve 33 can be controlled to be closed, so that the minerals in the water can meet the standard in the large flow rate.

For example, referring to FIG. 6, in an expected large flow rate, when a new kind of mineral is added into the water, the first valve body 62 can be controlled to be in the state of not allowing water to flow through; the second valve body 72 can be controlled to be in the state of allowing water to flow through; the first control valve 13 and the third control valve 33 can be controlled to be closed; and the second control valve 23 can be controlled to be opened. In this case, the first connection waterway 60 is blocked. The acceleration filter element 32 and the mineralization filter element 12 are connected through the second connection waterway 70. The water containing the accelerant can flow to the mineralization filter element 12 through the second connection waterway 70, thereby accelerating the release of minerals from the mineralization filter element 12, to make the minerals in the water to meet the standard. The inhibition waterway 20 is unblocked, so that the water containing the inhibitory substance can flow to the water outlet waterway 50. The inhibition filter element 22 can include a filter material that releases minerals, thereby adding the new kind of mineral into the water. For example, the inhibition filter element 22 includes a zeolite filter material described below. Zeolite released (dissolved) by the zeolite filter material can adsorb harmful substances such as heavy metals, ammonium, and hydrogen compounds in water, which greatly improves the water quality. In addition, zeolite can further adjust the pH value of water, to improve the taste of drinking water and maintain a healthy state of a human body.

In an embodiment, the first valve body 62 is a switch valve. The first connection pipeline 61 can be controlled to be in a connected and disconnected state by controlling the first valve body 62 to be opened or closed.

It can be understood that in other embodiments, the first valve body 62 can be a check valve. Specifically, when the inhibition waterway 20 is connected between the water inlet waterway 40 and the water outlet waterway 50, the second control valve 23 is opened. In this case, a resistance of the water flowing towards the second control valve 23 through the inhibition filter element 22 along the inhibition pipeline 21 is less than a resistance of the water flowing towards the check valve along the first connection pipeline 61. Therefore, the water flowing through the inhibition filter element 22 will not flow towards the mineralization filter element 12 through the check valve (the first valve body 62) along the first connection pipeline 61, but will flow towards the water outlet waterway 50 along the inhibition pipeline 21. When the mineralization filter element 12 is in a soaked state, the second control valve 23 is closed, and the water flowing through the inhibition filter element 22 cannot flow towards the water outlet waterway 50 along the inhibition pipeline 21. Therefore, the water flows towards the mineralization filter element 12 through the check valve (the first valve body 62) along the first connection pipeline 61, thereby inhibiting the release of minerals from the mineralization filter element 12.

In an embodiment, the second valve body 72 is a switch valve. The second connection pipeline 71 can be controlled to be in a connected and disconnected state by controlling the second valve body 72 to be opened or closed.

It can be understood that in other embodiments, the second valve body 72 can be a check valve. Specifically, when the acceleration waterway 30 is connected between the water inlet waterway 40 and the water outlet waterway 50, the third control valve 33 is opened. In this case, a resistance of the water flowing towards the third control valve 33 through the acceleration filter element 32 along the acceleration pipeline 31 is less than a resistance of the water flowing towards the check valve (the second valve body 72) along the second connection pipeline 71. Therefore, the water flowing through the acceleration filter element 32 will not flow towards the mineralization filter element 12 through the check valve (the second valve body 72) along the second connection pipeline 71, but will flow towards the water outlet waterway 50 along the acceleration pipeline 31. When the mineralization filter element 12 is in the middle to late stage of its service life, or in a scenario of a large flow rate, the third control valve 33 is closed. In this case, the acceleration waterway 30 is blocked, and the water flowing through the acceleration filter element 32 cannot flow towards the water outlet waterway 50 along the acceleration pipeline 31. Therefore, the water flows towards the mineralization filter element 12 along the second connection pipeline 71, thereby accelerating the release of minerals from the mineralization filter element 12 and ensuring that the mineral content of the water meets the standard.

In an embodiment, the mineralization waterway system 100 further includes a controller (not shown). The controller is electrically connected to the first control valve 13, the second control valve 23, and the third control valve 33. In this way, the controller can control opening and closing of the first control valve 13, the second control valve 23, and the third control valve 33, thereby enhancing the intelligence of the waterway system. When the first valve body 62 and the second valve body 72 use the switch valves, the controller is electrically connected to the switch valves to control the switch valves to be opened and closed.

In an embodiment, the first control valve 13, the second control valve 23, the third control valve 33, and the switch valves are all electromagnetic valves. Of course, in other embodiments, the first control valve 13, the second control valve 23, the third control valve 33, and the switch valves can further use other valves.

In an embodiment, the mineralization waterway system 100 further includes a flow detector for detecting a flow rate of water. Since the flow detector is used to detect the flow rate of the water, it is determined whether the water has a large flow rate, thus determining whether the second connection pipeline 71 is unblocked.

In an embodiment, the flow detector is a flow meter. Of course, in specific applications, as an alternative implementation solution, the flow detector can further use other detection equipment, such as a flow velocity sensor.

In an embodiment, the flow detector is electrically connected to the controller. The flow detector can transmit an obtained water flow rate signal to the controller. The controller can control opening or closing of the valve bodies according to the water flow rate signal.

In an embodiment, the mineralization waterway system 100 further includes a Total Dissolved Solids (TDS) detector. The TDS detector is configured to detect a TDS value of the water. In specific applications, the controller is electrically connected to the TDS detector, and the TDS detector can transmit an obtained TDS value to the controller. The controller controls opening or closing of the valve bodies according to the TDS value.

In an embodiment, the mineralization filter element 12 includes a metasilicic-acid-containing filter material; the acceleration filter element 32 includes an alkaline filter material; and the inhibition filter element 22 includes a zeolite filter material.

Silicon is one of the essential trace elements for a human body, and it tends to decrease significantly with age in the human body. Modern medicine has shown that silicon has an impact on synthesis of bone tissues and is related to bone growth and bone structures. Silicon plays a physiological role in the process of bone calcification and can promote bone growth. Insufficient intake of silicon can lead to a decrease in bone calcium content. Lack of silicon in a body can further lead to growth retardation, resulting in skeletal abnormalities, deformities (especially in the skull), and underdeveloped teeth or enamel. Silicon can further enhance the strength of elastic fibers of blood vessels, especially intimal elastic layers, thereby forming a barrier that effectively hinders lipid invasion. This property enables silicon to have an effect of resisting atherosclerosis, can maintain the integrity of the elastic fibers and mesenchyme, and thus prevent formation of atherosclerotic plaques. Silicon can further remove fat deposited on inner walls of blood vessels. This mechanism can alleviate arteriosclerosis and cardiovascular and heart diseases.

Silicon required by a human body generally comes from water, and the silicon in the water exists in the form of metasilicic acid, so that it is easily absorbed by the human body and the skin. Therefore, since the mineralization filter element 12 contains the metasilicic-acid-containing filter material, the mineralization filter element 12 can release metasilicic acid into the water, which is beneficial to the health of the human body.

Water with a pH value between 7.0 and 9.0 is the best for the health of the human body. Configuring the acceleration filter element 32 to include the alkaline filter material is beneficial for maintaining the water within the pH range of 7.0 to 9.0, which is then beneficial to the health of the human body.

The inhibition filter element 22 is configured to include the zeolite filter material, which can release (dissolve out) zeolite. The zeolite is a porous mineral, which can inhibit the dissolution of metasilicic acid and has excellent adsorption performance of adsorbing impurities and pollutants in the water, such as heavy metal ions, chlorine, fluorine, organic matters, and germs. It helps to improve the quality of drinking water and reduces potential harms to the human body. Furthermore, the zeolite can further remove peculiar smell and bad taste from the water, to improve the taste of the drinking water.

It can be understood that in other embodiments, the mineralization filter element 12 can further include a filter material containing other minerals, such as copper, calcium, magnesium, potassium, strontium, and zinc. It should be noted that when the mineralization filter element 12 includes the filter material containing other minerals, a corresponding acceleration filter material is matched in the acceleration filter element 32, and a corresponding inhibition filter material is matched in the inhibition filter element 22.

In an embodiment, the mineralization filter element 12 includes maifanite; the acceleration filter element 32 includes periclase; and the inhibition filter element 22 includes zeolite.

An embodiment of the present disclosure provides a mineralization water purifier, including the above mineralization waterway system 100. By using the above mineralization waterway system 100, an excessive mineral content of water can be effectively prevented, and the release of minerals from the mineralization filter element 12 can be accelerated, when the mineral content of the water does not meet the standard or in a large flow rate.

The above describes only preferred embodiments of the present disclosure and does not limit the patent scope of the present disclosure. Any equivalent structure transformation made using the specification and accompanying drawings of the present disclosure, or direct or indirect application in other related technical fields, falls within the scope of patent protection of the present disclosure.

What is claimed is:

1. A mineralization waterway system, comprising a mineralization waterway, an inhibition waterway, and an acceleration waterway, wherein the mineralization waterway, the inhibition waterway, and the acceleration waterway are arranged in parallel and are able to simultaneously or separately discharge water;
the mineralization waterway comprises a mineralization pipeline and a mineralization filter element arranged at the mineralization pipeline; the inhibition waterway comprises an inhibition pipeline and an inhibition filter element arranged at the inhibition pipeline; and the acceleration waterway comprises an acceleration pipeline and an acceleration filter element arranged at the acceleration pipeline;
the mineralization waterway system further comprises a first connection waterway and a second connection waterway; the first connection waterway is connected between the mineralization waterway and the inhibition waterway to allow water flowing through the inhibition filter element to enter the mineralization waterway; and the second connection waterway is connected between the mineralization waterway and the acceleration waterway to allow water flowing through the acceleration filter element to enter the mineralization waterway.

2. The mineralization waterway system according to claim 1, wherein the first connection waterway comprises a first connection pipeline and a first valve body arranged at the first connection pipeline.

3. The mineralization waterway system according to claim 2, wherein the first valve body is a switch valve or a check valve.

4. The mineralization waterway system according to claim 2, wherein the second connection waterway comprises a second connection pipeline and a second valve body arranged at the second connection pipeline.

5. The mineralization waterway system according to claim 4, wherein the second valve body is a switch valve or a check valve.

6. The mineralization waterway system according to claim 1, wherein the mineralization waterway further comprises a first control valve for controlling the mineralization pipeline to be opened and closed; the first control valve is arranged at an upstream end of the mineralization filter element;
one end of the first connection waterway is connected between the first control valve and the mineralization filter element; and one end of the second connection waterway is connected between the first control valve and the mineralization filter element.

7. The mineralization waterway system according to claim 1, wherein the inhibition waterway further comprises a second control valve for controlling the inhibition pipeline to be opened and closed; the second control valve is arranged at a downstream end of the inhibition filter element; and the other end of the first connection waterway is connected between the inhibition filter element and the second control valve.

8. The mineralization waterway system according to claim 1, wherein the acceleration waterway further comprises a third control valve for controlling the acceleration pipeline to be opened and closed; the third control valve is arranged at a downstream end of the acceleration filter element; and the other end of the second connection waterway is connected between the acceleration filter element and the third control valve.

9. The mineralization waterway system according to claim 1, further comprising a water inlet waterway and a water outlet waterway, wherein the mineralization waterway, the inhibition waterway, and the acceleration waterway are connected in parallel between the water inlet waterway and the water outlet waterway.

10. The mineralization waterway system according to claim 1, further comprising a flow detector for detecting a flow rate of water.

11. The mineralization waterway system according to claim 1, further comprising further comprising a Total Dissolved Solids (TDS) detector for detecting a TDS value of water.

12. The mineralization waterway system according to claim 1, wherein the mineralization filter element comprises a metasilicic-acid-containing filter material; the acceleration filter element comprises an alkaline filter material; and the inhibition filter element comprises a zeolite filter material.

13. The mineralization waterway system according to claim 12, wherein the mineralization filter element comprises maifanite; the acceleration filter element comprises periclase; and the inhibition filter element comprises zeolite.

14. A mineralization water purifier, comprising a mineralization waterway system according to claim 1.

15. The mineralization water purifier according to claim 14, wherein the first connection waterway comprises a first connection pipeline and a first valve body arranged at the first connection pipeline.

16. The mineralization water purifier according to claim 15, wherein the second connection waterway comprises a second connection pipeline and a second valve body arranged at the second connection pipeline.

17. The mineralization water purifier according to claim 14, wherein the mineralization waterway further comprises a first control valve for controlling the mineralization pipeline to be opened and closed; the first control valve is arranged at an upstream end of the mineralization filter element;
one end of the first connection waterway is connected between the first control valve and the mineralization filter element; and one end of the second connection waterway is connected between the first control valve and the mineralization filter element.

18. The mineralization water purifier according to claim 14, wherein the inhibition waterway further comprises a second control valve for controlling the inhibition pipeline to be opened and closed; the second control valve is arranged at a downstream end of the inhibition filter element; and the other end of the first connection waterway is connected between the inhibition filter element and the second control valve.

19. The mineralization water purifier according to claim 14, wherein the acceleration waterway further comprises a third control valve for controlling the acceleration pipeline to be opened and closed; the third control valve is arranged at a downstream end of the acceleration filter element; and the other end of the second connection waterway is connected between the acceleration filter element and the third control valve.

20. The mineralization water purifier according to claim 14, further comprising a water inlet waterway and a water outlet waterway, wherein the mineralization waterway, the inhibition waterway, and the acceleration waterway are connected in parallel between the water inlet waterway and the water outlet waterway.
